(19) United States
(12) Patent Application Publication
(10) Pub. No.: US 2006/0133337 A1
(43) Pub. Date: Jun. 22, 2006

(54) Route optimization method for network mobile service in IPv6 networks

(75) Inventors: Yoon Young An, Taejon (KR); Woo Seop Rhee, Taejon (KR); You Ze Cho, Daegu (KR)

Correspondence Address: MAYER, BROWN, ROWE & MAW LLP, 1909 K STREET, N.W., WASHINGTON, DC, 20006, US

(73) Assignee: ELECTRONICS AND TELECOMMUNICATIONS RESEARCH INSTITUTE

(21) Appl. No.: 11/209,861

(22) Filed: Aug. 24, 2005

(30) Foreign Application Priority Data
Dec. 20, 2004 (KR) 2004-108905

(51) Int. Cl. H04Q 7/24; H04L 12/28

(52) U.S. Cl. 370/338; 370/400

(57) ABSTRACT

A route optimization method for a mobile network service in IPv6 is disclosed. The route optimization method includes a) generating a binding update (BA) message at a home agent by using an address of a correspondent node and data information included in a home agent binding cache and transmitting the BA update message to the correspondent node when a mobile router performs a handover; b) extracting information from the binding update message and performing a binding operation by adding an entry to a correspondent node binding cache; c) transmitting a routing expanding header to a mobile router by using the binding information; d) processing the routing expanding header at the mobile router and transmitting the data packet to the mobile node; and e) directly transmitting a data packet to the mobile node through the mobile router. Therefore, network source is efficiently used and a communication performance is improved.

### BACKGROUND OF THE INVENITON

1. Field of the Invention

The present invention relates to a route optimization method for a network mobile service in IPv6 based networks, and more particularly, to a route optimization method for providing an optimized route without passing through a home agent for communication between a correspondent node and a mobile node in IPv6 based networks when a mobile router performs a handover to other subnet.

2. Description of the Related Art

When a mobile router performs a handover to a foreign link, following conventional steps are performed for providing continuous communication between a mobile node included in the mobile router and a correspondent node without interruption.

The mobile router sends a binding update message to a home agent for establishing a two-way tunnel between the mobile router and the home agent at a first step. The home agent transmits a packet received from the correspondent node to the mobile router through the two-way tunnel at a second step. The mobile router transmits the packet from the home agent to the mobile node.

In the conventional network mobile service, the mobile router cannot be bounded to the correspondent node because the mobile router does not know an address of the correspondent node. Data packets are always passed through the home agent for communication between the mobile node and the correspondent node.

As mentioned above, the mobile router is only bounded to the home agent and the correspondent node and the mobile node are always communicated thought the home agent in the conventional network mobile service in IPv6 networks. Therefore, the conventional network mobile service in IPv6 networks does not provides an optimized route between the mobile node and the correspondent node for communication.

### SUMMARY OF THE INVENTION

Accordingly, the present invention is directed to a route optimization method for a network mobile service in IPv6 networks, which substantially obviates one or more problems due to limitations and disadvantages of the related art.

It is an object of the present invention to provide a route optimization method for providing an optimized route of a communication between a mobile node and a correspondent node without passing through a home agent when a mobile router performs a handover to other subnet in a network mobile service in IPv6 networks by binding a mobile router and the correspondent node based on a binding update message and establishing a communication between the mobile node and the correspondent node by using a routing expending header received from the correspondent node.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a route optimization method for a network mobile service in an IPv6 networks, including a) generating a binding update message at a home agent by using an address of a correspondent node obtained from a packet transmitted from the correspondent node to the home agent and data information included in a home agent binding cache, and transmitting the generated binding update message to the correspondent node when a mobile router performs a handover to a foreign link; b) extracting data information included in a mobile router binding list from the binding update message received from the home agent and performing a binding operation by adding an entry to a correspondent node binding cache; c) transmitting a data packet having a routing expanding header to a mobile router by using the binding information added to the correspondent node when the data packet is transmitted from a correspondent node to a mobile router; d) processing the routing expanding header at the mobile router and transmitting the data packet to the mobile node; and e) directly transmitting a data packet to the mobile node through the mobile router.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention, are incorporated in and constitute a part of this application, illustrate embodiments of the invention and together with the description serve to explain the principle of the invention. In the drawings:

FIG. 1 is a diagram illustrating a system providing a network mobile service where a preferred embodiment of the present invention is implemented for explaining fundamental operations of the network mobile service in IPv6 network;

FIG. 2 shows a binding information table of the network mobile service in IPv6 networks of FIG. 1;

FIG. 3 is a diagram showing a system providing a mobile network service for explaining a route optimization method for the mobile network service in IPv6 networks in accordance with a preferred embodiment of the present invention;

FIG. 4 is a flowchart of a route optimization method for a mobile network service in IPv6 networks in accordance with a preferred embodiment of the present invention;

FIG. 5 shows a binding information table used for a route optimization method for a network mobile service in IPv6 networks shown in FIG. 3; and

FIG. 6 is a diagram showing a structure of a routing expanding header used for a route optimization method of FIG. 3.

### DETAILED DESCRIPTION OF THE INVENTION

Reference will now be made in detail to the preferred embodiments of the present invention, examples of which are illustrated in the accompanying drawings.

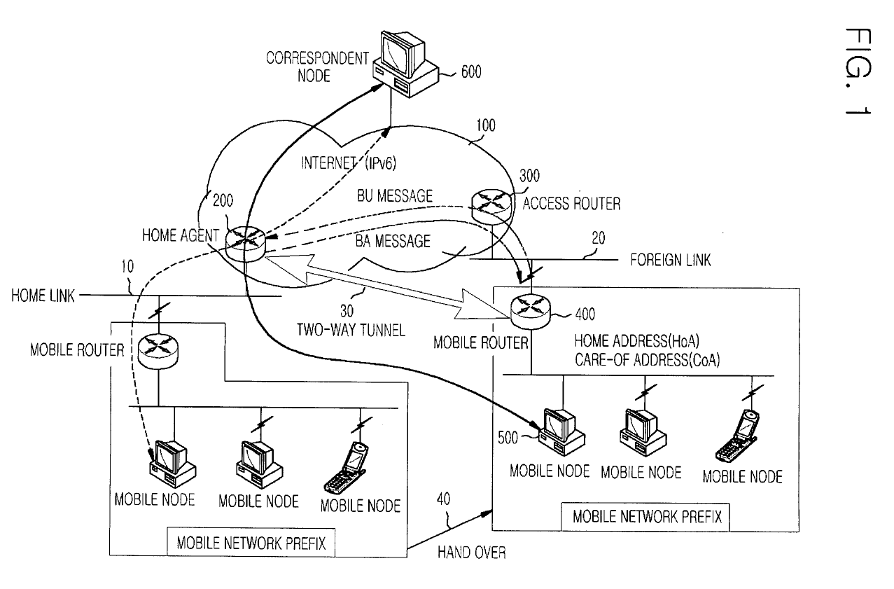

FIG. 1 is a diagram illustrating a system providing a network mobile service where a preferred embodiment of the present invention is implemented for explaining fundamental operations of the network mobile service in IPv6 network.

As shown in FIG. 1, a system for providing a network mobile service in IPv6 networks includes a home agent 200, an access router 300, a mobile router 400, a mobile node 500 and a correspondent node 600.

The mobile router 400 receives a home address (HoA) from the home agent 200 on a home link 10. And, the mobile node 500 receives a home address by receiving a mobile network prefix from the mobile router 400. The mobile node 500 communicates to the correspondent node 600 through the mobile router 400 and the home agent 200.

If the mobile router 400 performs a handover 40 to a foreign link 20 during communicating, following steps are performed.

At first, the mobile router 400 receives prefix information from the access router 300 of the foreign link 20 and generates new care-of address (CoA). After generating, the mobile router 400 transmits a binding update message (BU) to the home agent 200. If the mobile router 400 receives a BA message as a response of the BU message, the mobile router 400 and the home agent 200 are bound and a two-way tunnel 30 is established.

After establishing the two-way tunnel 30, the home agent 200 transmits data packets received from the correspondent node 600 to the mobile router 400 through the two-way tunnel 30. After handover 40, the correspondent node continuously transmits the data packet to the home agent 200 because the correspondent node 600 does not recognize the handover 40 of the mobile router 400. Therefore, the home agent 200 uses the two-way tunnel 30 as a route to send the data packet received from the correspondent node 600 to the handovered mobile router 400.

That is, the mobile router 400 transmits the received data packet from the home agent 200 to the mobile node 500 through the two-way tunnel 30. Also, the mobile router 400 transmits the data packet received from the mobile node to the home agent 200. The mobile node 500 continuously uses the mobile network prefix since the mobile node 500 is included in the mobile router 400. Thus, the mobile node 500 does not need to recognize the handover 40 of the mobile router 400. Accordingly, if a communication is established between the correspondent node 600 and the mobile router 400, the correspondent node can communicate to the mobile node 500 without any additional operations.

The handover 40 in FIG. 1 maintains the communication between the mobile node 500 and the correspondent node 600 without interrupt by detecting movement of the mobile router 400 and binding the mobile router 400 and the home agent 200 for establishing the two-way tunnel 30. However, the mobile router 400 cannot be bound to the correspondent node 600 because the mobile router 400 does not know a home address of the correspondent node 600. Therefore, an optimized route from the mobile router 400 to the correspondent node 600 for communication is not provided. That is, the mobile router 400 always communicates with the correspondent node 600 passing through the home agent 200.

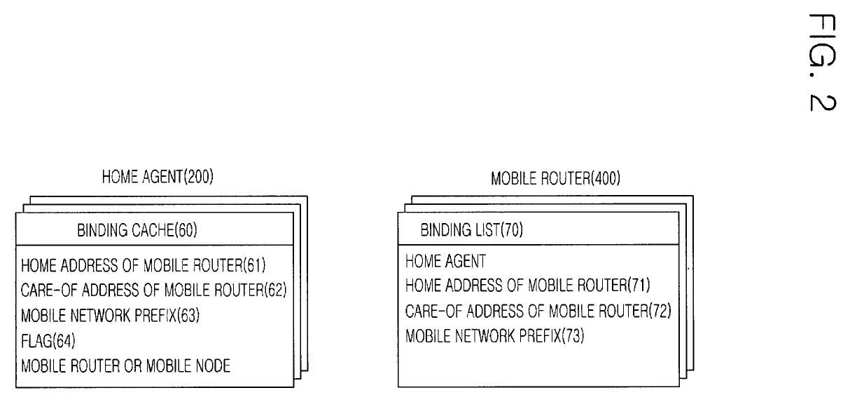

FIG. 2 shows a binding information table of the network mobile service in IPv6 networks of FIG. 1.

As shown in FIG. 2, the mobile router 400 transmits the BU message to the home agent 200 by putting biding information including a home address 61, 71 of a mobile router, a care-of address 62, 72 of a mobile router, a mobile network prefix 63, 73, and a R flag 64 representing a mobile router for establishing the two-way tunnel between the mobile router 400 and the home agent 200. The home agent 200 receives the BU message with the binding information from the mobile router 400 and stores the received BU message with the binding information in a binding cache 60. The mobile router 400 also maintains the binding information as a binding list 70.

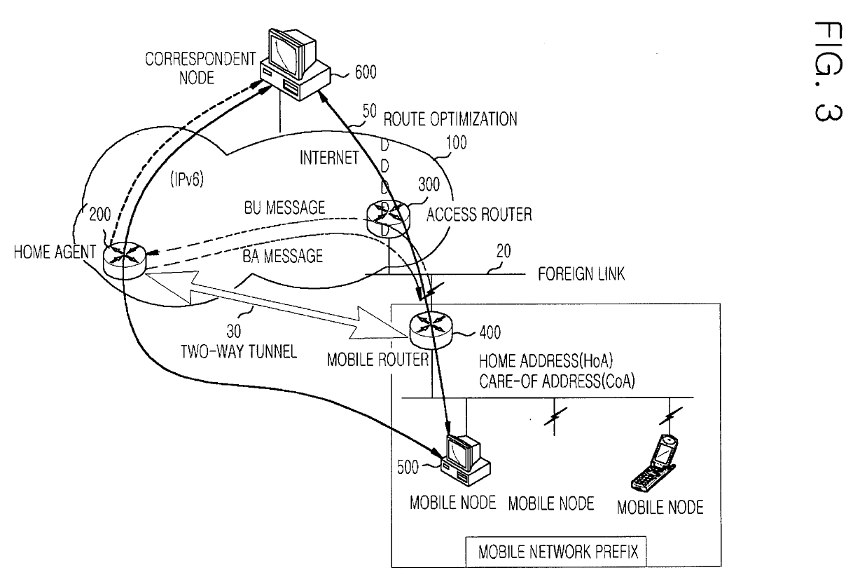

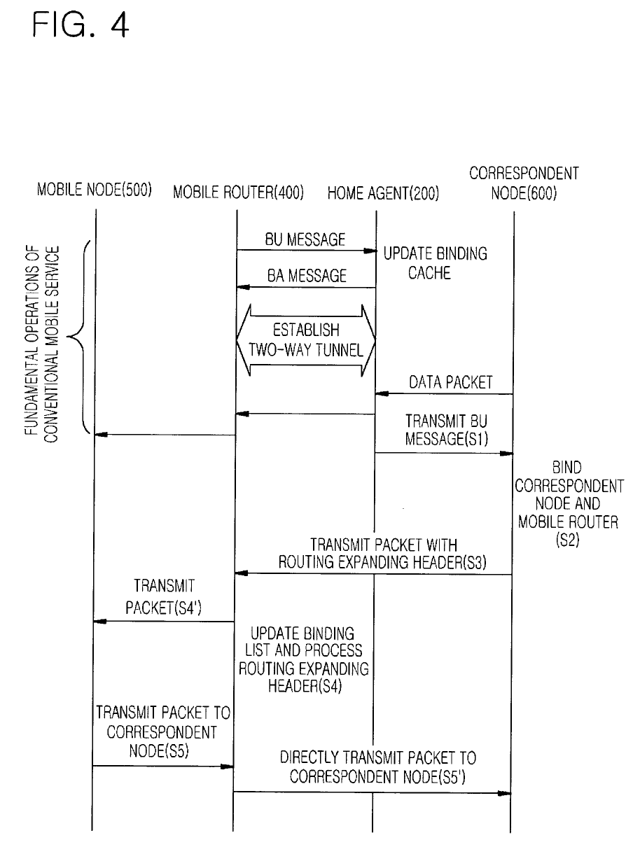

FIG. 3 is a diagram showing a system providing a mobile network service for explaining a route optimization method for the mobile network service in IPv6 networks in accordance with a preferred embodiment of the present invention and FIG. 4 is a flowchart of a route optimization method for a mobile network service in IPv6 networks in accordance with a preferred embodiment of the present invention.

As shown in FIGS. 3 and 4, the route optimization method includes a first step S1 for transmitting a BU message to a correspondent node 600 in order to bind the correspondent node 600 and a mobile router 400 by a home agent 200 after establishing a two-way tunnel described in FIG. 1; a second step S2 for processing the BU message at the correspondent node 600; a third step S3 for transmitting a data packet to the mobile router 400 by using a routing expanding header 800 at the correspondent node 600; a fourth step S4 and S4′ for processing the received packet from the correspondent node 600, transmitting the processed packet to the mobile node 500 and updating a binding list 70 at the mobile router 400; and a fifth step S5, S5′ for directly transmitting the packet received from the mobile node 500 to the correspondent node 600 without passing through the home agent 200 at the mobile router 400.

In the first step S1, the home agent 200 transmits the BU message to the correspondent node 600 for binding the correspondent node 600 and the mobile router 400. The home agent 200 recognizes the address of the correspondent node 600 by receiving and processing the packet transmitted from the correspondent node 600 to the mobile node 500. Also, the home agent 200 generates the BU message by using binding information stored in the biding cache 60. The binding information includes a home address 61 of the mobile router, a care-of address 62 of the mobile router, a mobile network prefix 63, and an R flag 64. The generated BU message is transmitted to the correspondent node. The mobile router 400 does not know the address of the correspondent node 600 so the mobile router 400 cannot generate the BU message for performing the binding operation. Therefore, the home agent 200 generates the BU message.

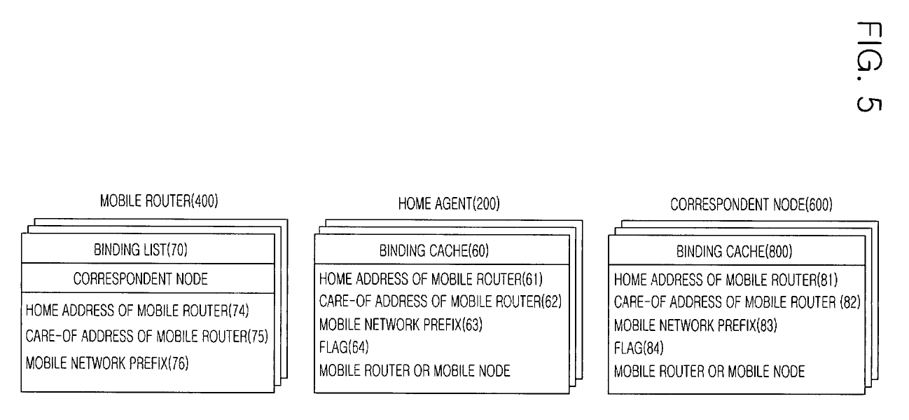

In the second step S2, the correspondent node 600 receives the BU message from the home agent 200 and adds the binding information included in the BU message to the binding cache. That is, the correspondent node 600 receives the binding information including a home address 81 of the mobile router, a care-of address 82 of the mobile router and an entry having a mobile network prefix 83 and stores the received binding information to the binding cache 80. The correspondent node 600 and the mobile router 400 are bound by using the received binding information. The binding cache of the correspondent node is shown in FIG. 5.

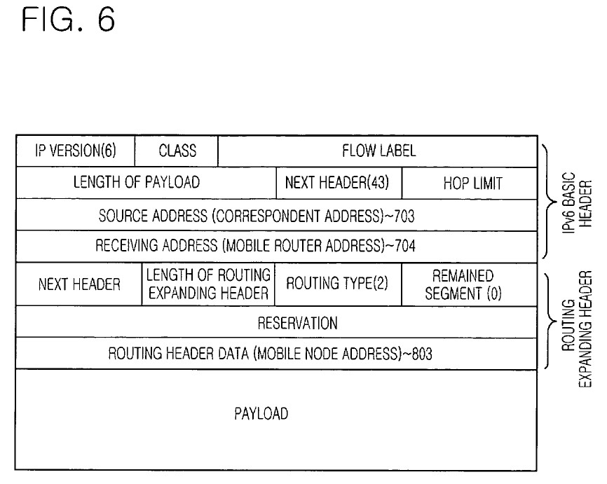

In the third step S3, the correspondent node 600 transmits a data packet to the mobile router 400 through an optimized route 50 without passing through the home agent 200 since the correspondent node 600 and the mobile router 400 are bound in the second step S2. A routing expanding header 800 is putted to an IPv6 header 700 and the routing expanding header 800 is transmitted for transmitting the data packet from the correspondent node 600 to the mobile router 400 through the mobile node 500 without passing through the home agent 200. A structure of the routing expanding header 800 is shown in FIG. 6.

In the fourth step S4, S4′, the mobile router 400 received the data packet from the correspondent node 600 and processes the routing expanding header 800 of the data packet. The mobile router 400 transmits the processed routing expanding header 800 of the data packet to the mobile node 500 and adds the entry having the binding information between the mobile router 400 and the correspondent node 600 to the binding list 70. After adding, the mobile router 400 eliminates entries having binding information between the mobile router and the home agent from the binding list 70.

In the fifth step S5, S5′, the mobile router 400 directly transmits the data packet from the mobile node 500 to the correspondent node 600 without transmitting the packet to the home agent 200.

FIG. 5 shows a binding information table used for a route optimization method for a network mobile service in IPv6 networks shown in FIG. 3.

As shown in FIG. 5, the mobile router 400 and the correspondent node 600 are bound for optimizing a route between the mobile router 400 and the correspondent node 200. The mobile router 400 transmits a BU message to the home agent and the BU message includes the binding information having the home address 61 of the mobile router, the care-of address 62, the mobile prefix 63 and an R flag representing the mobile router. The binding information is stored in the binding cache 60 of the home agent 200. The home agent 200 puts the binding information stored in the binding cache 60 in a BU message and transmits the BU message to the correspondent node 600. The correspondent node 600 received the BU message and stores the binding information included in the BU message. If the correspondent node 600 transmits a data packet to the mobile router 400 after storing the binding information in the correspondent node 600, the mobile router 400 adds the binding information of the correspondent node 600 to the binding list 70 and eliminates binding information between the home agent 200 from the binding list 70.

FIG. 6 is a diagram showing a structure of a routing expanding header used for a route optimization method of FIG. 3.

A data packet is transmitted to the mobile node 500 through the mobile router 400 for transmitting the data packet from the correspondent node 600 to the mobile node 500 through the optimized route 50. The routing expanding header 800 is added to the IPv6 basic header 700 and transmitted for transmitting the data packet from the correspondent node 600 to the mobile node 500 through the optimized route 50. As shown in FIG. 6, the IPv6 basic header includes an IP version field 701, a next header field 702, a source address field 703 and a receiving address 704. The IP version field 701 is set to have ‘6’ and the next header field 702 is set to have ‘43’ because the routing expanding header 800 is followed by the IPv6 basic header. The source address field 703 is set to have the address of the correspondent node 600 since the packet is transmitted to the correspondent node 600. The receiving address field 704 is set to have the address of the mobile router 400 because the data packet is passed through the mobile router 400. The routing expanding header 800 includes a routing type field 801, a remained segment field 802 and a routing expanding header data field 803. The routing type field 801 is set to have ‘2’ because the routing expanding header is for a mobile service and the remained segment field 802 is set to have ‘1’. The routing expanding header data field 803 is set to have the address of the mobile node 500 which is an address of a receiving node. When the mobile router 400 receives the packet from the correspondent node 600, the mobile router 400 sets the receiving address field 704 to have the address of the mobile node 500 stored in the routing expanding header data field 803 and transmits the data packet to the mobile node 500.

As mentioned above, the route optimization method of the present invention transmits the data packet from the mobile node to the correspondent node through the optimized route without passing through the home agent by performing binding operation between the correspondent node and the mobile router. Therefore, network source is efficiently used and a communication performance is improved because a data path becomes shorter.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A route optimization method for a mobile network service in IPv6, comprising the steps of:
a) generating a binding update message at a home agent by using an address of a correspondent node obtained from a packet transmitted from the correspondent node to the home agent and data information included in a home agent binding cache, and transmitting the generated binding update message to the correspondent node when a mobile router performs a handover to a foreign link;
b) extracting data information included in a mobile router binding list from the binding update message received from the home agent and performing a binding operation by adding an entry to a correspondent node binding cache;
c) transmitting a data packet having a routing expanding header to a mobile router by using the binding information added to the correspondent node when the data packet is transmitted from a correspondent node to a mobile router;
d) processing the routing expanding header at the mobile router and transmitting the data packet to the mobile node; and
e) directly transmitting a data packet to the mobile node through the mobile router.

2. The method of claim 1, wherein the step b includes the step b-1) adding an entry having binding information of a correspondent node to a binding list at the mobile router and eliminating an entry having binding information of a home agent from the binding list.

3. The method of claim 1, wherein the home agent binding cache includes a home address of a mobile router, a care-of address, a mobile prefix and flag information.

4. The method of claim 1, further comprising the steps of;
generating new care-of address by receiving prefix information from an access router of a foreign link from a mobile router when the mobile router performs a handover to the foreign link;
transmitting a binding update message from the mobile router to a home agent;
responding for the binding update message at the home agent; and
establishing a two-way tunnel by binding a mobile router and a home agent based on the responding,
wherein the steps for generating, transmitting, responding and establishing are performed before performing the step a).

5. The method of claim 1, wherein the routing expanding header includes:
a basic header having an IP version, a next header, a source address set to have an address of a correspondent node and a receiving address set to have an address of a mobile router; and
a routing expanding header having a routing type, a remained segment and a routing expanding header data set to have an address of a mobile node which is a receiving node address of a packet.
